(19) United States
(12) Patent Application Publication
(10) Pub. No.: US 2012/0320293 A1
(43) Pub. Date: Dec. 20, 2012

(54) Pixel Circuit and Driving Method Thereof

(75) Inventors: Chih-Haw Wang, Gueishan Taoyuan (TW); Pei-Hsun Wu, Gueishan Taoyuan (TW)

(73) Assignee: Benq Materials Corp., Gueishan Taoyuan (TW)

(21) Appl. No.: 13/356,716

(22) Filed: Jan. 24, 2012

(30) Foreign Application Priority Data
Jun. 14, 2011 (TW) 100120693

(51) Int. Cl. G02F 1/1343

(52) U.S. Cl. 349/38

(57) ABSTRACT

A pixel circuit for a liquid crystal display device includes first and second capacitor units, a voltage regulating unit, and a switching unit. The first capacitor unit includes first and second liquid crystal capacitors. The second capacitor unit includes a third liquid crystal capacitor. The voltage regulating unit is coupled to the first and second liquid crystal capacitors thereby enabling the first and second liquid crystal capacitors to be configured with different voltages when a voltage is applied to the first capacitor unit. The switching unit is coupled to the first and second capacitor units. A data voltage is applied to the first and second capacitor units when the switching unit is enabled by a first scan signal. A common voltage is applied to the second capacitor unit when the switching unit is enabled by a second scan signal.

### CROSS-REFERENCE TO RELATED APPLICATION

This application claims priority of Taiwanese Application No. 100120693, filed on Jun. 14, 2011, the disclosure of which is incorporated herein by reference.

### BACKGROUND OF THE INVENTION

1. Field of the Invention

The present invention relates to a pixel circuit and a method of driving the same, more particularly to a pixel circuit that is capable of improving the viewing angle of a liquid crystal display device and to a method of driving the pixel circuit.

2. Description of the Related Art

Shown in FIG. 1 is a liquid crystal display (LCD) device 1 that includes a phase retardation film 11 and that is capable of presenting stereoscopic images, and polarizing glasses 2 that include a left-handed circular polarizer 21 and a right-handed circular polarizer 22. The phase retardation film 11 comprises a plurality of left-handed polarization zones 111 and a plurality of right-handed polarization zones 112 that are alternately disposed along a vertical direction.

During operation, light corresponding to images that are associated with the left eye (hereinafter referred to as the left-eye images) is perceived by the left eye via the left-handed polarization zones 111 and the left-handed circular polarizer 21, and light corresponding to images that are associated with the right eye (hereinafter referred to as the right-eye images) is perceived by the right eye via the right-handed polarization zones 112 and the right-handed circular polarizer 22. Each corresponding pair of left-eye and right-eye images may combine to form a stereoscopic image in which objects are seen as having depth or three dimensions.

Shown in FIG. 2 is a schematic diagram of the LCD device 1, showing an adjacent pair of the left-handed and right-handed polarization zones 111, 112 defined by the phase retardation film 11, and first and second pixel circuits 12a, 12b corresponding respectively to the left-handed and right-handed polarization zones 111, 112.

The first pixel circuit 12a is conductive to drive corresponding rotation of liquid crystals in the left-handed polarization zone 111. The second pixel circuit 12b is conductive to drive corresponding rotation of liquid crystals in the right-handed polarization zone 112. However, such a configuration has the drawback of crosstalk interference. Specifically, if a viewing angle of one of the pixel circuits 12a, 12b is too wide (e.g., wider than the angle “θᵥ”), light emitted from said one of the pixel circuits 12a, 12b will enter the polarization zone 111, 112 to which the other of the pixel circuits 12a, 12b corresponds. As a result, the eye to which the other of the pixel circuits 12a, 12b corresponds will perceive light from both of the pixel circuits 12a, 12b.

FIG. 3 illustrates a configuration that is capable of alleviating the above-mentioned drawback of crosstalk interference, where a gap width “W” between the phase retardation film 11 and the pixel circuits 12a, 12b is relatively shortened, thereby preventing the light emitted from said one of the pixel circuits 12a, 12b from entering the polarization zone 111, 112 to which the other of the pixel circuits 12a, 12b corresponds. Further, the gap width “W” is in a negative relation to the angle “θᵥ”. However, such a configuration has the drawback of relatively low yield rate and relatively high production cost due to an increase in production difficulty attributed to the relatively narrow gap width “W”.

FIG. 4 shows another configuration that is capable of alleviating the above-mentioned drawback of crosstalk interference, where each of the pixel circuits 12a, 12b has a shield area 120 that is opaquely screened. The shield area 120 has a width that is in a positive relation to the angle “θᵥ”.

In comparison with the configuration shown in FIG. 3, the configuration shown in FIG. 4 generally has a lower production cost and is relatively suitable for application to LCD devices with larger dimensions. There are two methods of achieving opaque screening of the shield area 120. Referring to FIG. 5, each pixel of the images corresponds to a pixel region 5, which may be divided into first and second sub-regions 51, 52, the second sub-region 52 corresponding to the shield area 120.

One of the methods includes disposing an opaque screening component at the second sub-region 52. However, such a method has the drawback of reduced luminance in both two-dimensional (2D) applications and three-dimensional (3D) applications. Referring to FIG. 6, the other of the methods includes disposing a pixel circuit 12′ in each pixel region 5, and operatively associating the pixel circuit 12′ to liquid crystal molecules to which the pixel region 5 corresponds. In a 3D application, the pixel circuit 12′ may be configured to control the liquid crystal molecules to which the pixel region 5 corresponds in a manner that light may traverse through the first sub-region 51 and may not traverse through the second sub-region 52. Width of the second sub-region 52 may be controlled through controlling the liquid crystal molecules, thereby increasing the width of the shield area 120 in vertical direction.

The pixel circuit 12′ includes a first controlling switching element 121, a second controlling switching element 122, a main sub-region capacitor unit 123, and a secondary sub-region capacitor unit 124.

The first controlling switching element 121 includes a first terminal 1211 for receiving a first data voltage, a second terminal 1212, and a control terminal 1213 for receiving a scan signal, and is operable to enter a conductive state according to the scan signal.

The second controlling switching element 122 has a first terminal 1221 for receiving a second data voltage, a second terminal 1222, and a control terminal 1223 for receiving the scan signal, and is operable to enter a conductive state according to the scan signal. It should be noted that the first and second data voltages are different.

The main sub-region capacitor unit 123 includes a first liquid crystal capacitor 127 that corresponds to the first sub-region 51 of the pixel region 5, and a first storage capacitor 128. The first liquid crystal capacitor 127 includes first terminal 1271 that is electrically coupled to the second terminal of the first controlling switching element 1212, and a second terminal 1272 for receiving a common voltage. The first storage capacitor 128 is coupled in parallel with the first liquid crystal capacitor 127.

The secondary sub-region capacitor unit 124 includes a second liquid crystal capacitor 131 that corresponds to the second sub-region 52 of the pixel region 5, and a second storage capacitor 132. The second liquid crystal capacitor 131 includes a first terminal 1311 electrically coupled to the second terminal 1222 of the second controlling switching element 122, and a second terminal 1312 for receiving the common voltage. The second storage capacitor 132 is coupled in parallel with the second liquid crystal capacitor 131.

In 2D applications, the first data voltage and the second data voltage are related to image information. Upon receipt of the scan signal, the first controlling switching element 121 and the second controlling switching element 122 are operable to enter the conductive state for applying the first and second data voltages to the main and secondary sub-region capacitor units 123, 124, thereby enabling driving of the liquid crystal molecules corresponding to the first liquid crystal capacitor 127 by the first data voltage, and driving of the liquid crystal molecules corresponding to the second liquid crystal capacitor 132 by the second data voltage, respectively. In such a configuration, the problem of color washout is relatively alleviated.

In 3D applications, the first data voltage is related to image information, and the second data voltage is set to be identical to the common voltage. As a result, the liquid crystal molecules corresponding to the second liquid crystal capacitor 131 operate in a light-screening state, where light is opaquely screened by the liquid crystal molecules, throughout the application.

Although luminance of light emitted from the pixel circuit 12′ in 2D applications in not reduced, luminance of light emitted from the same in 3D applications is significantly reduced since the liquid crystal molecules are driven by a single data voltage (i.e., the first data voltage) instead of two data voltages. Consequently, the LCD device 1 has a relatively narrow viewing angle and exhibits significant color washout.

### SUMMARY OF THE INVENTION

Therefore, an object of the present invention is to provide a pixel circuit that is capable of alleviating the aforesaid drawbacks of the prior art.

According to the present invention, a pixel circuit for a liquid crystal display device includes: a first capacitor unit including a first liquid crystal capacitor and a second liquid crystal capacitor; a second capacitor unit including a third liquid crystal capacitor; a voltage regulating unit electrically coupled to the first liquid crystal capacitor and the second liquid crystal capacitor; and a switching unit for receiving a first scan signal, a second scan signal, a data voltage, and a common voltage, and electrically coupled to the first capacitor unit and the second capacitor unit.

When the switching unit is enabled by the first scan signal, the data voltage is applied to the first capacitor unit and the second capacitor unit. The voltage regulating unit is configured to be enabled when the data voltage is applied to the first capacitor unit such that voltage being applied to the second liquid crystal capacitor differs from that being applied to the first liquid crystal capacitor. The switching unit is enabled by the second scan signal to apply the common voltage to the second capacitor unit.

Another object of the present invention is to provide a method of driving a pixel circuit that includes a first capacitor unit and a second capacitor unit, each of which includes a liquid crystal capacitor.

According to the present invention, a method of driving a pixel circuit that includes a first capacitor unit and a second capacitor unit, each of which includes a liquid crystal capacitor, includes the steps of: a) applying a data voltage and a common voltage to a switching unit; b) configuring the switching unit for applying the data voltage to the first capacitor unit and the second capacitor unit; c) configuring the switching unit for stopping applying the data voltage to the first capacitor unit and the second capacitor unit; d) configuring the switching unit for applying the common voltage to the second capacitor unit; e) configuring the switching unit for stopping applying the common voltage to the second capacitor unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional LCD device and a pair of polarizing glasses;

FIG. 2 is a schematic diagram to illustrate a configuration of a phase retardation film and pixel circuits of the LCD device;

FIG. 3 is a schematic diagram to illustrate another configuration of the phase retardation film and the pixel circuits;

FIG. 4 is a schematic diagram to illustrate yet another configuration of the phase retardation film and the pixel circuits;

FIG. 5 is a schematic diagram to illustrate a pixel region;

FIG. 6 is a circuit diagram of the conventional pixel circuit;

FIG. 7 is a circuit diagram of the preferred embodiment of a pixel circuit according to the present invention;

FIG. 8 is a timing diagram to illustrate time sequences of signals when the pixel circuit of the preferred embodiment is operated in a two-dimensional application;

FIG. 9 is a flowchart of steps of a method of driving the pixel circuit of the preferred embodiment in a three-dimensional application;

FIG. 10 is a timing diagram to illustrate time sequences of signals when the pixel circuit of the preferred embodiment is operated in the three-dimensional application; and

FIG. 11 is a circuit diagram of another preferred embodiment of a pixel circuit according to the present invention.

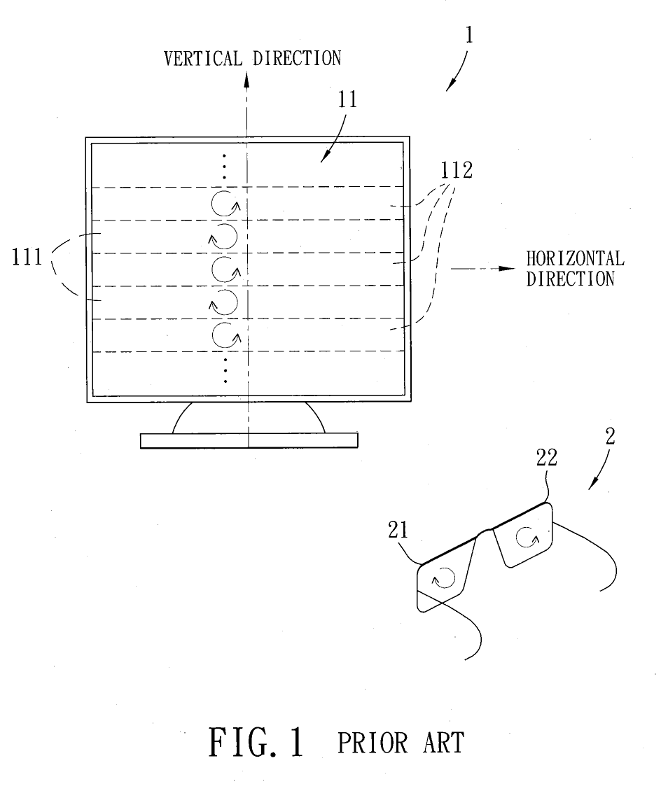

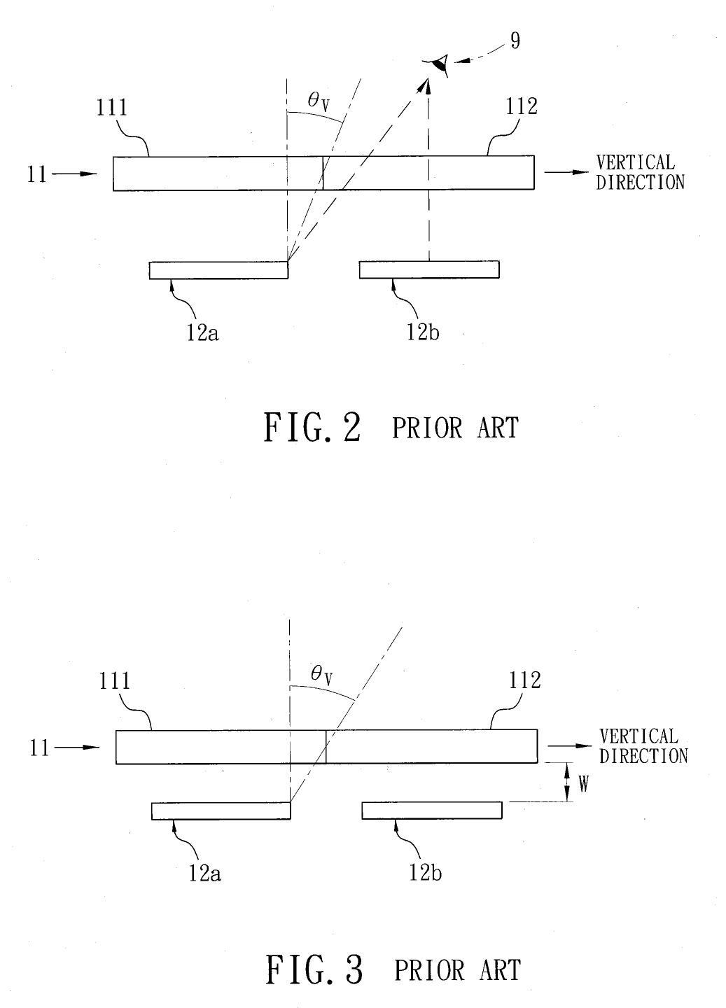

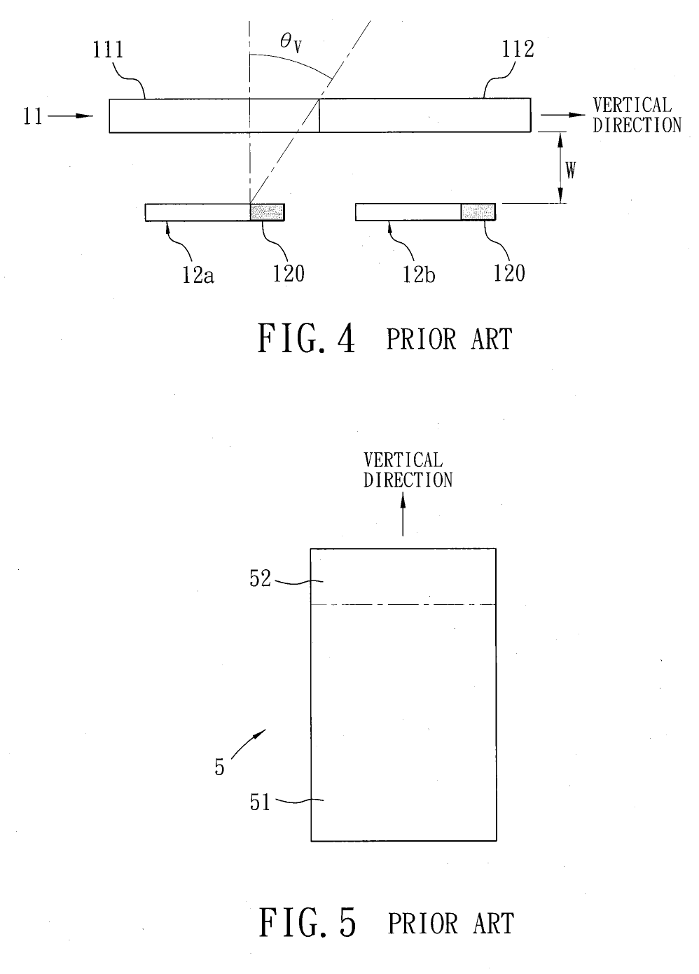

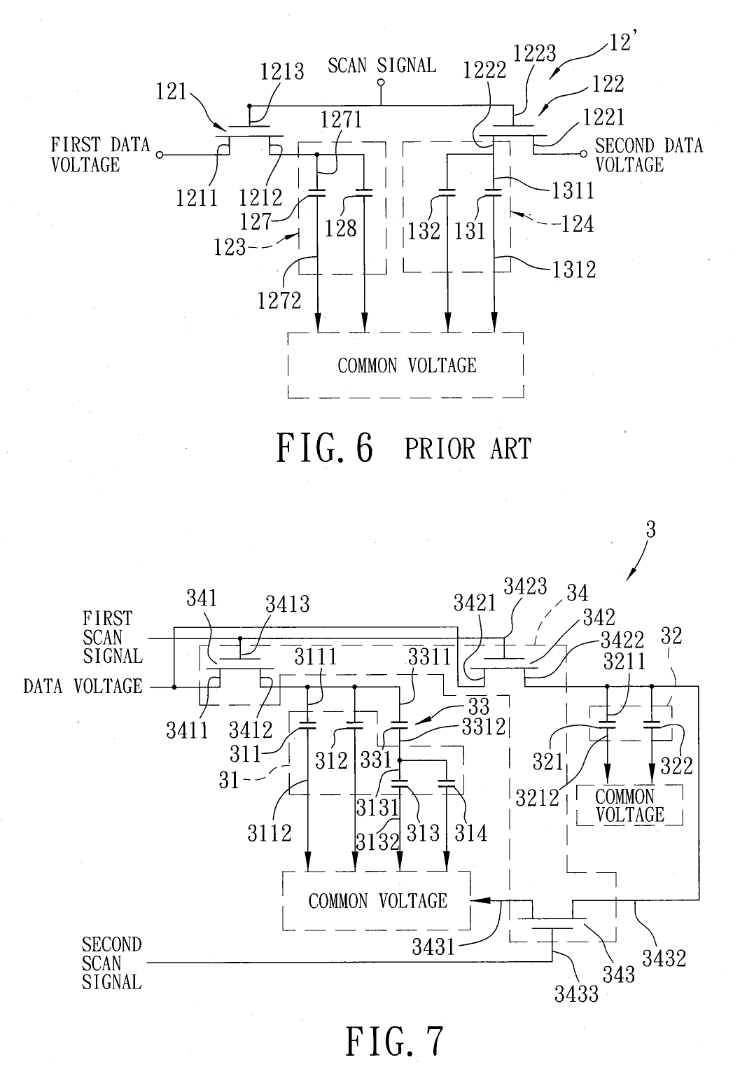

### DETAILED DESCRIPTION OF THE PREFERRED EMBODIMENTS

Before the present invention is described in greater detail, it should be noted that like elements are denoted by the same reference numerals throughout the disclosure.

Referring to FIG. 7, the preferred embodiment of a pixel circuit 3 for a liquid crystal display (LCD) device, according to the present invention, includes a first capacitor unit 31, a second capacitor unit 32, a voltage regulating unit 33, and a switching unit 34.

The first capacitor unit 31 includes a first liquid crystal capacitor 311 and a first storage capacitor 312 that are electrically coupled in parallel, and a second liquid crystal capacitor 313 and a second storage capacitor 314 that are electrically coupled in parallel. The first liquid crystal capacitor 311 has a first terminal 3111, and a second terminal 3112 for receiving a common voltage. The second liquid crystal capacitor 313 has a first terminal 3131, and a second terminal 3132 for receiving the common voltage.

The second capacitor unit 32 includes a third liquid crystal capacitor 321 and a third storage capacitor 322 that are electrically coupled in parallel. The third liquid capacitor 321 has a first terminal 3211, and a second terminal 3212 for receiving the common voltage.

The first liquid crystal capacitor 311 is conductive to control liquid crystal molecules corresponding to the first sub-region 51 of the pixel region 5 illustrated in FIG. 5. The second liquid crystal capacitor 313 and the third liquid crystal capacitor 321 are conductive to control liquid crystal molecules corresponding to the second sub-region 52 of the pixel region 5 illustrated in FIG. 5.

The voltage regulating unit 33 is electrically coupled to the first terminal 3111 of the first liquid crystal capacitor 311 and the first terminal 3131 of the second liquid crystal capacitor 313, and is configured to be enabled when a data voltage (to be described hereinafter) is applied to the first capacitor unit 31 such that voltage being applied to the first liquid crystal capacitor 311 differs from that being applied to the second liquid crystal capacitor 313. The voltage regulating unit 33 includes a coupling capacitor 331 that is electrically coupled in series to the second liquid crystal capacitor 313. Series connection of the coupling capacitor 331 and the second liquid crystal capacitor 313 is connected electrically in parallel to the first liquid crystal capacitor 311. In detail, the coupling capacitor 331 has a first terminal 3311 that is electrically coupled to the first terminal 3111 of the first liquid crystal capacitor 311, and a second terminal 3312 that is electrically coupled to the first terminal 3131 of the second liquid crystal capacitor 313.

The switching unit 34 is for receiving a first scan signal, a second scan signal, the data voltage, and the common voltage, and is electrically coupled to the first capacitor unit 31 and the second capacitor unit 32. The switching unit 34 is enabled by the first scan signal to apply the data voltage to the first capacitor unit 31 and the second capacitor unit 32. The switching unit 34 is further enabled by the second scan signal to apply the common voltage to the second capacitor unit 32.

The switching unit 34 includes a first controlling switching element 341, a second controlling switching element 342, and a third controlling switching element 343, each of which is, in this embodiment, a thin film transistor having a first terminal (source) 3411, 3421, 3431, a second terminal (drain) 3412, 3422, 3432, and a control terminal (gate) 3413, 3423, 3433. However, the controlling switching elements 341-343 may be otherwise in other embodiments.

Regarding the first controlling switching element 341, the first terminal 3411 is for receiving the data voltage, the second terminal 3412 is electrically coupled to the first terminal 3111 of the first liquid crystal capacitor 311 of the first capacitor unit 31 and the first terminal 3311 of the coupling capacitor 331, and the control terminal 3413 is for receiving the first scan signal. The first controlling switching element 341 is conductive to make electrical connection between the first and second terminals 3411, 3412 when the first scan signal is received by the first controlling switching element 341.

Regarding the second controlling switching element 342, the first terminal 3421 is electrically coupled to the first terminal 3411 of the first controlling switching element 341, the second terminal 3422 is electrically coupled to the first terminal 3211 of the third liquid crystal capacitor 321, and the control terminal 3423 is for receiving the first scan signal. The second controlling switching element 342 is conductive to make electrical connection between the first and second terminals 3421, 3422 when the first scan signal is received by the second controlling switching element 342.

Regarding the third controlling switching element 343, the first terminal 3431 is for receiving the common voltage, the second terminal 3432 is electrically coupled to the second terminal 3422 of the second controlling switching element 342, and the control terminal 3433 is for receiving the second scan signal. The third controlling switching element 343 is conductive to make electrical connection between the first and second terminals 3431, 3432 when the second scan signal is received by the third controlling switching element 343.

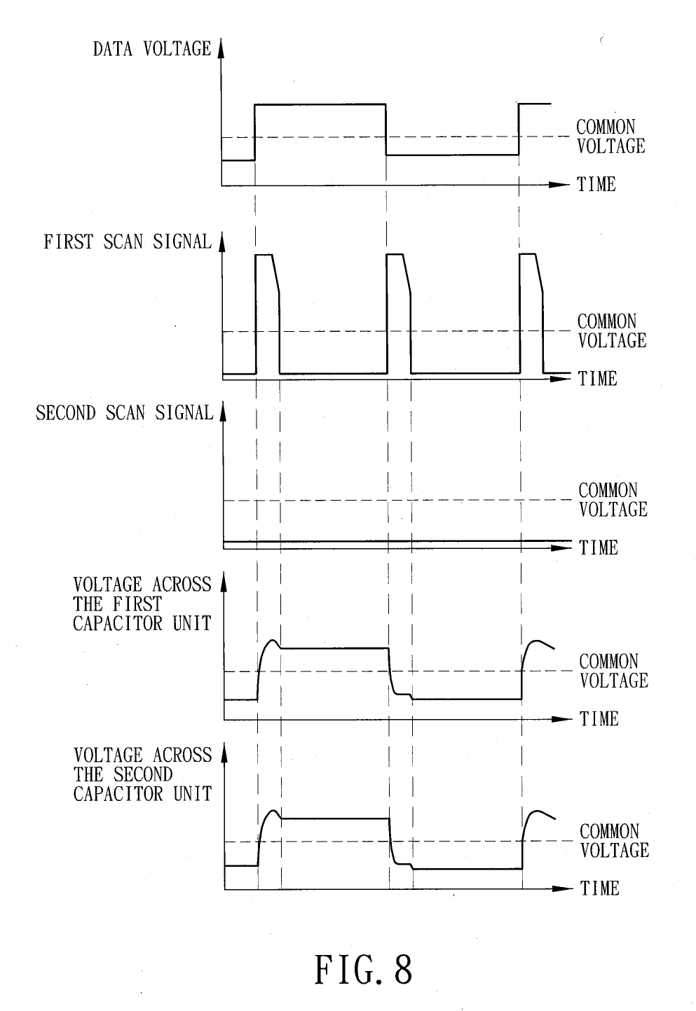

Shown in FIG. 8 is a timing diagram of the pixel circuit 3 in a two-dimensional (2D) application. When 2D images (i.e., non-stereoscopic images) are being presented, the third controlling switching element 343 is non-conductive to break the electrical connection between the first terminal 3431 and the second terminal 3432 thereof, to be enabled the common voltage is not applied to the first terminal 3211 of the third liquid crystal capacitor 321 of the second capacitor unit 32 via the third controlling switching element 343.

When the switching unit 34 receives the first scan signal, each of the first controlling switching element 341 and the second controlling switching element 342 is conductive to make the electrical connection between the first terminal 3411, 3421 and the second terminal 3421, 3422 thereof, such that the data voltage is applied to the first terminal 3111 of the first liquid crystal capacitor 311 via the first terminal 3411 and the second terminal 3412 of the first controlling switching element 341, and to the second capacitor unit 32 via the first terminal 3421 and the second terminal 3422 of the second controlling switching element 342.

The coupling capacitor 331 cooperates with the second liquid crystal capacitor 313 to achieve a voltage dividing effect, whereby voltage being applied to the first liquid crystal capacitor 311 is different from that being applied to the second liquid crystal capacitor 313. As a result, the liquid crystal molecule s controlled by the first liquid crystal capacitor 311 are driven by a first voltage to undergo a first rotation, and those controlled by the second liquid crystal capacitor 313 are driven by a second voltage to undergo a second rotation. The first and second voltages are different, and thus the first and second rotations are different. Such a dual-voltage driving technique generally results in a wider horizontal viewing angle compared to a single-voltage driving technique, which alleviates the problem of color washout.

Moreover, since the third controlling switching element 343 remains in a non-conductive state throughout the 2D application due to absence of the second scan signal, the common voltage is not applied to the first terminal 3211 of the third liquid crystal capacitor 321, and operation of the liquid crystal molecules to which the third liquid crystal capacitor 321 corresponds is not affected by the third liquid crystal capacitor 321. That is to say, effect of the second capacitor unit 32 may be disabled during the 2D application. Thus, when operated in a 2D application, the pixel circuit 3 is conductive to emit light at a relatively high luminance.

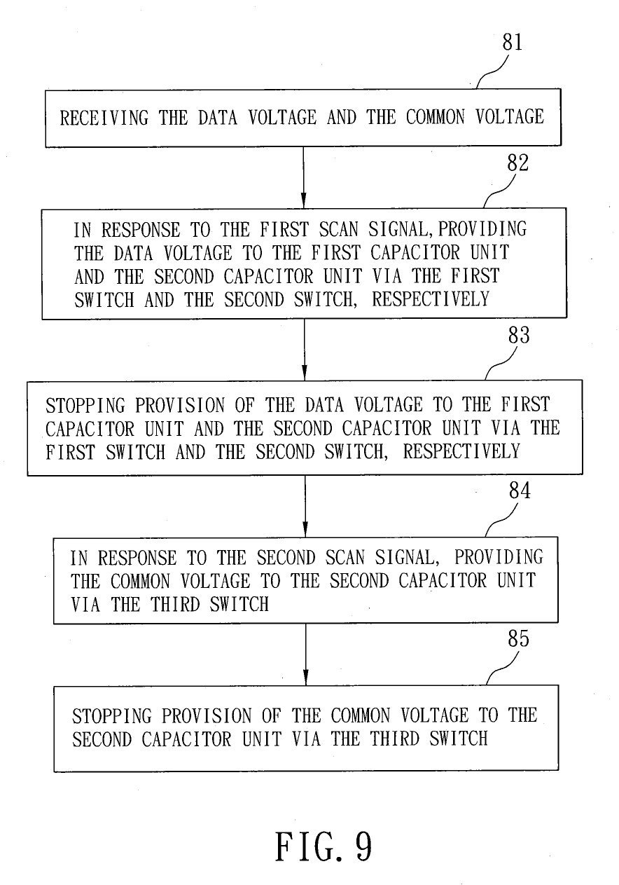

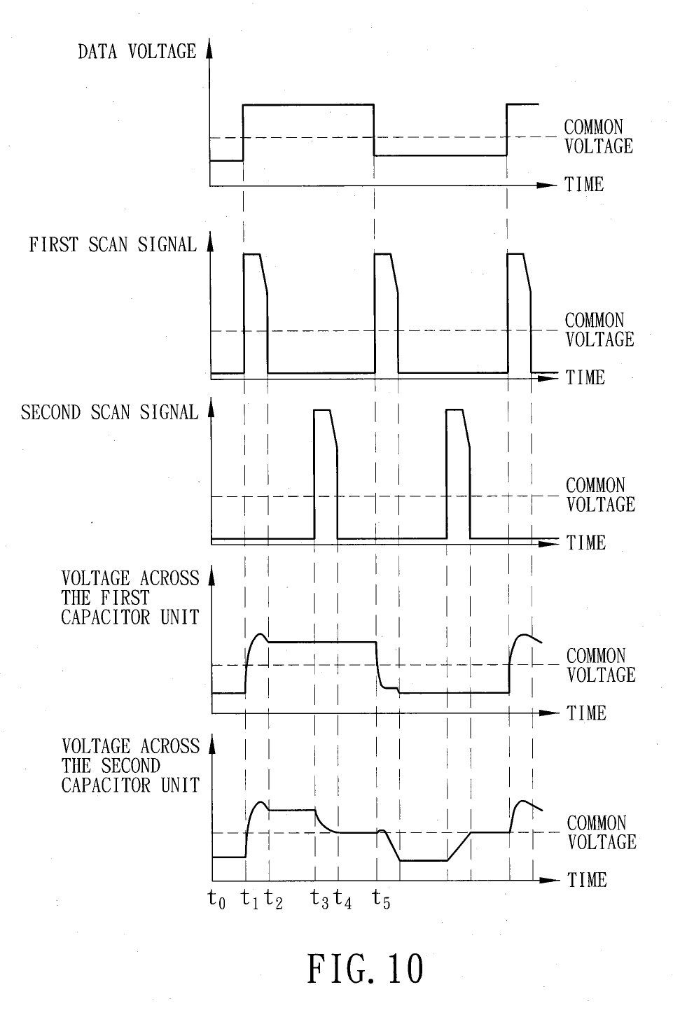

Shown in FIG. 9 is a flowchart of steps of a method of driving the pixel circuit 3 in a three-dimensional (3D) application. FIG. 10 shows a timing diagram of the pixel circuit 3 in the 3D application.

In step 81, the switching unit 34 is configured to receive the data voltage and the common voltage. This step is performed during a duration marked by t₁ and t₅.

In step 82, the switching unit 34 is configured to be enabled by the first scan signal for applying the data voltage to the first capacitor unit 31 and the second capacitor unit 32 via the first controlling switching element 341 and the second controlling switching element 342, respectively. This step is performed during a duration marked by t₁ and t₂.

In step 83, the switching unit 34 is configured to stop applying the data voltage to the first capacitor unit 31 and the second capacitor unit 32 via the first controlling switching element 341 and the second controlling switching element 342, respectively. This step is performed during a duration marked by t₂ and t₃.

In step 84, the switching unit 34 is configured to be enabled by the second scan signal for applying the common voltage to the second capacitor unit 32 via the third controlling switching element 343. This step is performed during a duration marked by t₃ and t₄.

During this step, since the third liquid crystal capacitor 321 receives the common voltage via the first terminal 3211 thereof (the second terminal 3212 thereof also receives the common voltage), the liquid crystal molecules controlled by the third liquid crystal capacitor 321 enters a light-screening state, where light is unable to pass through the liquid crystal molecules controlled by the third liquid crystal capacitor 321, thereby alleviating the aforesaid problem of crosstalk interference.

In addition, during this step, since voltage being applied to the first liquid crystal capacitor 311 differs from that being applied to the second liquid crystal capacitor 313, the pixel circuit 3 is able to achieve a wider horizontal viewing angle even in 3D applications.

In step 85, the switching unit 34 is configured to stop applying the common voltage to the second capacitor unit 32 via the third controlling switching element 343. This step is performed during a duration marked by t₄ and t₅.

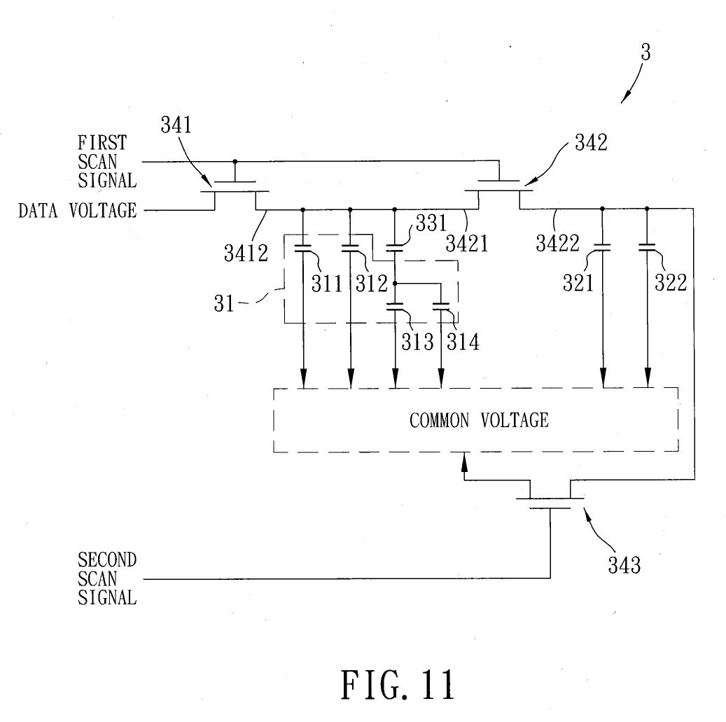

FIG. 11 shows the pixel circuit 3 of another preferred embodiment, where the first terminal 3421 of the second controlling switching element 342 is electrically coupled to the second terminal 3412 of the first controlling switching element 341.

In summary, through applying different voltages to the first liquid crystal capacitor 311 and the second liquid crystal capacitor 313, viewing angle of the pixel circuit 3 is improved in both 2D and 3D applications. Moreover, by virtue of the third controlling switching element 343, which enters the conductive state upon receipt of the second scan signal in a 3D application, the pixel circuit 3 is able to achieve a wider viewing angle and to exhibit relatively low crosstalk interference with luminance comparable to light emitted from the pixel circuit 3 during a 2D application (i.e., luminance is not compromised).

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A pixel circuit for a liquid crystal display device, comprising:
a first capacitor unit including a first liquid crystal capacitor and a second liquid crystal capacitor;
a second capacitor unit including a third liquid crystal capacitor;
a switching unit for receiving a first scan signal, a second scan signal, a data voltage, and a common voltage, and electrically coupled to said first capacitor unit and said second capacitor unit;
a voltage regulating unit electrically coupled to said first liquid crystal capacitor and said second liquid crystal capacitor, wherein said voltage regulating unit is configured to be enabled when the data voltage is applied to said first capacitor unit such that the voltage being applied to said second liquid crystal capacitor differs from that being applied to said first liquid crystal capacitor;
wherein, when said switching unit is enabled by the first scan signal, the data voltage is applied to said first capacitor unit and said second capacitor unit; and
wherein, when said switching unit is enabled by the second scan signal, the common voltage is applied to said second capacitor unit.

2. The pixel circuit as claimed in claim. 1, wherein said switching unit includes:
a first controlling switching element having a first terminal for receiving the data voltage, a second terminal that is electrically coupled to said first capacitor unit, and a control terminal for receiving the first scan signal such that said first controlling switching element makes conduction according to the first scan signal;
a second controlling switching element having a first terminal that is electrically coupled to one of said first and second terminals of said first controlling switching element, a second terminal that is electrically coupled to said second capacitor unit, and a control terminal for receiving the first scan signal such that said second controlling switching element makes conduction according to the first scan signal; and
a third controlling switching element having a first terminal for receiving the common voltage, a second terminal that is electrically coupled to said second terminal of said second controlling switching element, and a control terminal for receiving the second scan signal such that said third controlling switching element makes conduction according to the second scan signal;
wherein, when said switching unit is enabled by the first scan signal, said first controlling switching element and said second controlling switching element make conduction for applying the data voltage to said first capacitor unit and said second capacitor unit; and
when said switching unit is enabled by the second scan signal, said third controlling switching element makes conduction for applying the common voltage to said second capacitor unit.

3. The pixel circuit as claimed in claim 2, wherein each of said first controlling switching element, said second controlling switching element, and said third controlling switching element includes a thin film transistor having a source terminal to serve as said first terminal, a drain terminal to serve as said second terminal, and a gate terminal to serve as said control terminal.

4. The pixel circuit as claimed in claim 2, wherein said voltage regulating unit includes a coupling capacitor electrically connected in series to said second liquid crystal capacitor, series connection of said coupling capacitor and said second liquid crystal capacitor being connected electrically in parallel to said first liquid crystal capacitor.

5. The pixel circuit as claimed in claim 4, wherein:
said first liquid crystal capacitor includes a first terminal that is electrically coupled to said second terminal of said first controlling switching element, and a second terminal for receiving the common voltage;
said coupling capacitor includes a first terminal electrically coupled to said second terminal of said first controlling switching element, and a second terminal; and
said second liquid crystal capacitor includes a first terminal that is electrically coupled to said second terminal of said coupling capacitor, and a second terminal for receiving the common voltage.

6. The pixel circuit as claimed in claim 5, wherein said first capacitor unit further includes a first storage capacitor that is electrically connected in parallel to said first liquid crystal capacitor, and a second storage capacitor that is electrically connected in parallel to said second liquid crystal capacitor.

7. The pixel circuit as claimed in claim 5, wherein said third liquid crystal capacitor has a first terminal that is electrically coupled to said second terminal of said second controlling switching element, and a second terminal for receiving the common voltage.

8. The pixel circuit as claimed in claim 7, wherein said second capacitor unit further includes a third storage capacitor that is electrically connected in parallel to said third liquid crystal capacitor.

9. A method of driving a pixel circuit of a liquid crystal display device that includes a first capacitor unit, a second capacitor unit, a voltage regulating unit and a switching unit, the first capacitor unit including a first liquid crystal capacitor and a second liquid crystal capacitor, the second capacitor unit including a third liquid crystal capacitor, the voltage regulating unit being coupled to said first and second liquid crystal capacitors thereby enabling said first and second liquid crystal capacitors to be configured with different voltages when a voltage is applied to said first capacitor unit, said switching unit being coupled to said first and second capacitor units, said method comprising the steps of:
a) applying a data voltage and a common voltage to said switching unit;
b) configuring said switching unit for applying the data voltage to said first capacitor unit and said second capacitor unit;
c) configuring said switching unit to stop applying the data voltage to said first capacitor unit and said second capacitor unit;
d) configuring said switching unit for applying a common voltage to said second capacitor unit;
e) configuring said switching unit to stop applying a common voltage to said second capacitor unit.
